(19) United States
(12) Patent Application Publication
(10) Pub. No.: US 2007/0145036 A1
(43) Pub. Date: Jun. 28, 2007

(54) Battery operated throw/football blanket

(76) Inventor: Dorothy Faye Ratliff-Harris, Atlanta, GA (US)

Correspondence Address: DASCO;c/o Dorothy Faye Ratliff - Harris, 6750 Peachtree Ind. Blvd #1501, Atlanta, GA, 30360, US

(21) Appl. No.: 11/220,192

(22) Filed: Dec. 27, 2005

(51) Int. Cl. H05B 3/34

(52) U.S. Cl. 219/528

(57) ABSTRACT

The purpose of the modification is to improve the original concept of the electric blanket and make it portable. From my research, I realize battery packs are being used in all types of products. New technology is increasingly making the battery pack smaller and smaller. The results of my data concluded that a modification of the original concept of the electric blanket would have the same capability as the original electric blanket when attached to a battery pack. The data also concluded that making the electric blanket portable would modify the enhancement of the original product. In conclusion, I found that most things powered by electricity can be powered by batteries, i.e., generators. Therefore, I confirm my modification of the heated baby carriage blanket with the modification of the detachable, rechargeable battery pack i.e., electric blanket with reference to U.S. Pat. No. 2,993,979.

This is a battery operated football/throw blanket. The owner of this product is Dorothy Faye Ratliff-Harris, a U.S. citizen, residing at 6750 Peachtree Industrial Blvd., Atlanta, Ga. 30360.

This is no prior application pending before the U.S. Patent office. There is no rights to inventions made under any federal sponsored research or development.

### BACKGROUND OF THE INVENTION

This blanket would be used to keep warm in cold and inclement outdoor activities. There are no problems known to date of any prior technology for this invention.

### SUMMARY OF THE INVENTION

This product is a blanket/throw just like an original electric blanket/throw with one exception. This one is portable and battery-operated. It can be used as a blanket only keep warm during outdoor events. It works using a battery pack similar to those used in cell phones. No similar product has been found on the market.

### DRAWINGS

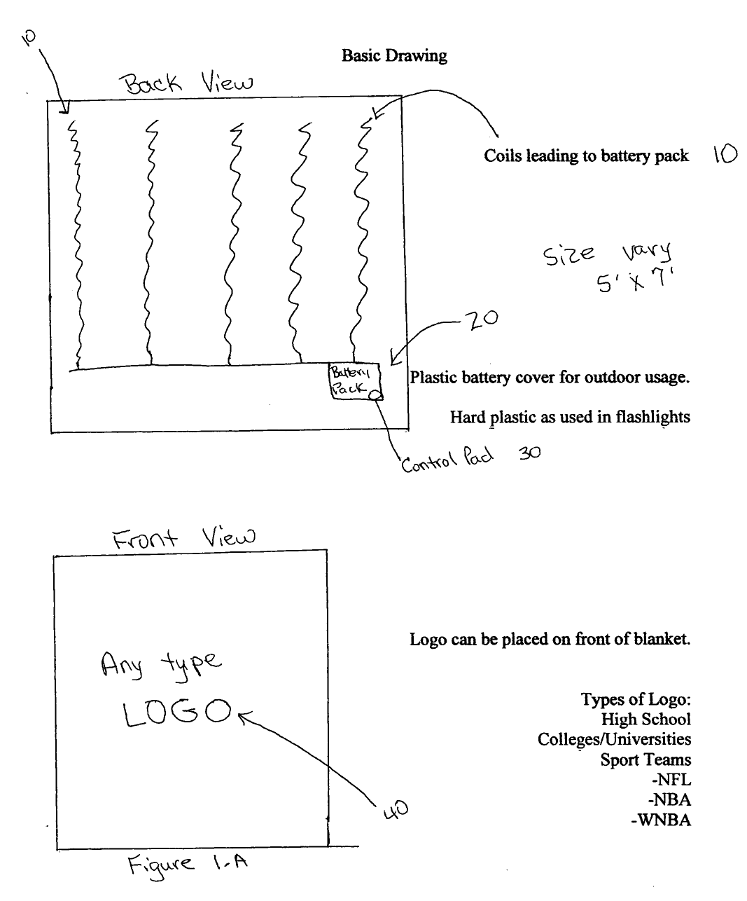

The enclosed drawings show a sample of the blanket. FIG. 1A is the front view which illustrate what can be placed on the blanket (40), which can be any type of Logo. FIG. 1B is the back view showing the coils and how they connect to the battery pack.

### DESCRIPTION

Instead of disposable or electric where an outlet or charger would be needed this blanket would be portable with a permanent battery pack similar to those used in cell phones. The blanket is washable once the pack (10) is removed. The temperature of the blanket would be controlled much like that of an electric blanket with a control pad (30). This blanket would be an improvement over the conventional electric blanket in that it is portable. FIG. 1A shows the front of the blanket. FIG. 1B is the coils (10) embedded within the blanket that connect to the battery pack (l0).

### CLAIM

The claim is the battery operated blanket/throw provides a service unfilled by any similar products.

### DISCLOSURE

The battery operated blanket/throw provides flexibility, portability and outdoor comfort.

What is claimed is:

1

. A battery operated throw blanket comprising: a throw/blanket with coils leading to a battery pack, contained in a compartment; the pack is the source of heat when plugged into the coils and turned on.

2. The battery operated throw blanket as recited in claim 1 wherein the battery pack includes an indicator light capable of emitting light when turned on.

3. The battery operated throw blanket as recited in claim 2 wherein the battery pack is comprised of durable plastic capable of withstanding frigid conditions.

4. The battery operated throw blanket as recited in claim 2 wherein the battery pack is detachable.

5. The battery operated throw blanket as recited in claim 1 wherein the blanket is washable.

6. The battery operated throw blanket as recited in claim 5 wherein the blanket is comprised of washable fabric of different size and color.

7. The battery operated throw blanket as recited in claim 6 wherein the blanket is comprised of a size as specified as a throw or a blanket of twin or full size.

8. The battery operated throw blanket as recited in claim 1 wherein the blanket is designed to be portable.

9. The battery operated throw blanket as recited in claim 1 wherein the blanket can have imprinted designs or logos from teams which may be sports comprised of secondary to higher education, professional or non-professional.

10. The battery operated throw blanket as recited in claim 9 wherein the blanket can be endorsed by healthcare providers as well.
